(19) United States
(12) Patent Application Publication
(10) Pub. No.: US 2004/0134074 A1
(43) Pub. Date: Jul. 15, 2004

(54) Gardening flower scissors with container

(76) Inventor: Chi-Sui Lin, Taichung Hsien (TW)

Correspondence Address: CHARLES E. BAXLEY, ESQUIRE, Hart, Baxley, Daniels & Holton, 5 Fl., 59 John St., New York, NY, 10038, US

(21) Appl. No.: 10/340,775

(22) Filed: Jan. 10, 2003

(51) Int. Cl. B26B 11/00; B26B 1/00

(52) U.S. Cl. 30/143; 30/144; 30/146; 30/152

(57) ABSTRACT

A gardening flower scissors with container comprising a container with several slices inside to form at least a knife space, a saw space and a scissors space to store a scissors, a knife and a saw to contains a scissors, a knife blade and a saw blade; the scissors, knife blade and the saw blade can be folded into and stored into the corresponding space or tuned outward for application; a cover can also fold and cover the container or open, when the cover covers the container, it can be a handle for users to grip.

### BACKGROUND OF THE INVENTION

I. Field of the Invention

This invention relates generally to a gardening tool and, more specifically, to a gardening flower scissors with container that has not only scissors but knife blade and saw blade, all the accessories can be folded into a container while not use for more safety and less volume.

II. Description of the Prior Art

Heretofore, it is known that a flower scissors, as shown in FIG. 1, is to have two handles each with a blade on one side in different shape; a pivot is installed in proper location to make it trim and open; a spring is installed between two handles to offer the bounce power when two blades trim.

When users want to put away the flower scissors, the closed scissors does not have a fixture to prevent the blades from opening, the volume of the closed scissors might not dramatically small; the blades are exposed and potentially danger of hurting. The spring might have elastic fatigue condition after certain period of time to make the scissors not easy and convenient to use.

### SUMMARY OF THE INVENTION

It is therefore a primary object of the invention to provide a gardening flower scissors with container that is stored inside a container while not using and protected with a cover to make the whole set in a safe and stable condition. The stored flower scissors is in a very small volume, easy to carry and easy to store. The present invention also has a knife blade and a saw blade; users can apply those functions. When the cover is on top of the container, it can be a grip of the scissors; the cover is in curve shape and easy for users to hold. The present invention does not apply spring to control the stretch of the blades to avoid the spring fatigue problem for longer product life.

In order to achieve the objective set forth, a gardening flower scissors with container in accordance with the present invention comprises a container with several slices inside to form at least a knife space, a saw space and a scissors space to store a scissors, a cover can also fold and cover the container or open; a scissors consists of a control handle, a first scissors blade and a second scissors blade with the wedged ends connected to the front of the container moveably inside the saw space with the pivot, the scissors can be folded into and stored into the corresponding space or tuned outward for application; when the scissors are stored inside the container, the cover covers the container to protect the scissors, when the scissors are turned outward for application, the cover covers the container to be a handle for users to grip.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the prior art;

FIG. 2 is an assembly view of the container of the present invention;

FIG. 3 is an assembly view of the container and the cover, and an assembly view of the scissors, knife blade and saw blade of the present invention;

FIG. 4 is a perspective view of the present invention;

FIG. 5 is another perspective view the present invention;

FIG. 6 is an application view of the knife blade in accordance with the present invention;

FIG. 7 is an application view of the saw blade in accordance with the present invention;

FIG. 8 is an application view of the scissors in accordance with the present invention;

FIG. 9A is a perspective view (I) of the opening scissors in accordance with the present invention;

FIG. 9B is a perspective view (II) of the opening scissors in accordance with the present invention;

FIG. 9C is a perspective view (III) of the opening scissors in accordance with the present invention;

FIG. 9D is a perspective view (IV) of the opening scissors in accordance with the present invention;

FIG. 10A is a perspective view (I) of the recovering scissors in accordance with the present invention;

FIG. 10B is a perspective view (II) of the recovering scissors in accordance with the present invention;

FIG. 10C is a perspective view (III) of the recovering scissors in accordance with the present invention.

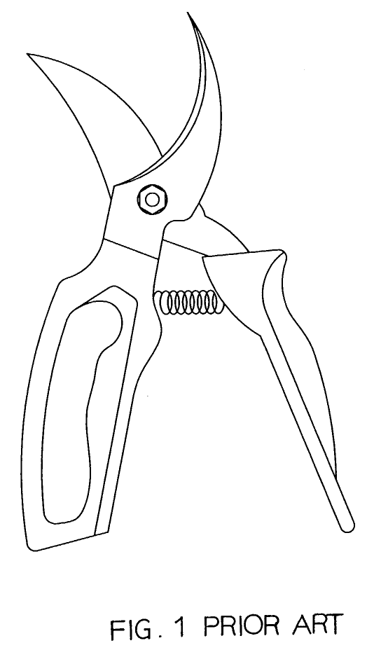

### DESCRIPTION OF THE PREFERRED EMBODIMENT

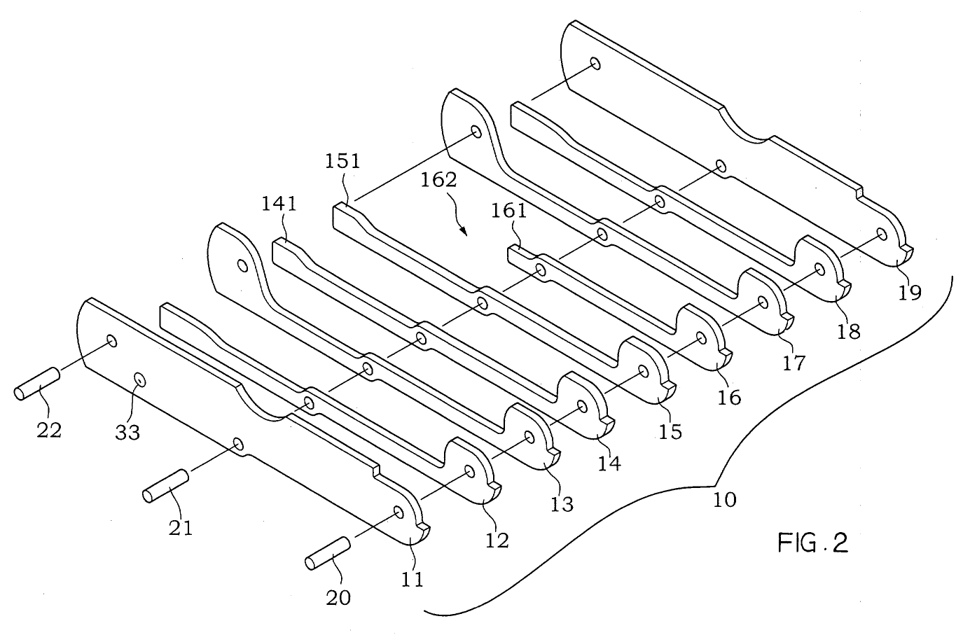

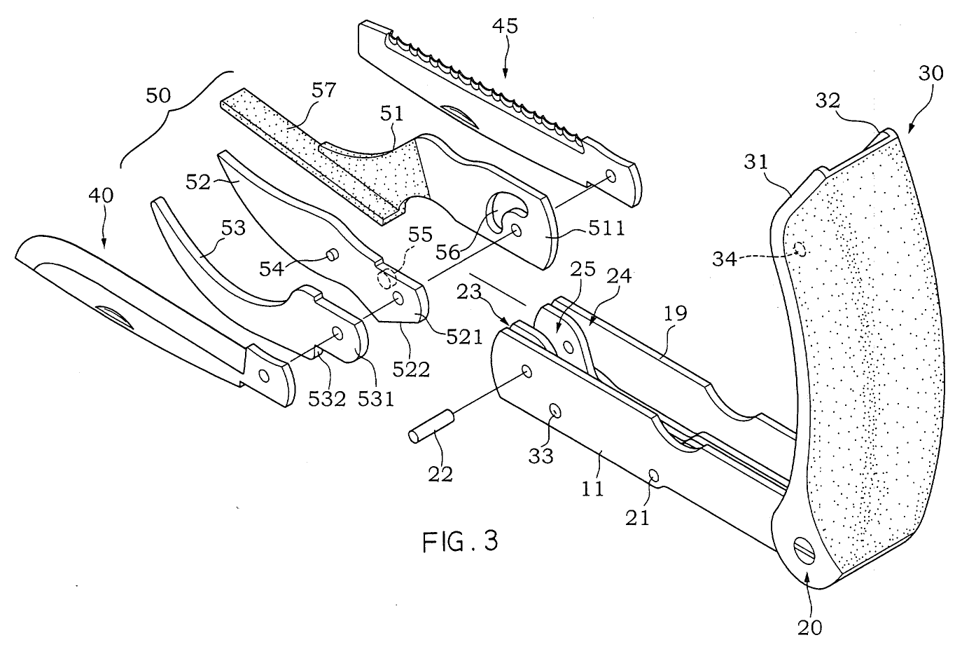

Referring to FIG. 2, and FIG. 3, the present invention is composed of a container (10) with several slice (11)˜(19) in different structures, different shapes inside; these slice (11)˜(19) are fixed on center and both ends with three pivot (20)(21)(22); the slice (11)˜(19) inside the container (10) form at least a knife space (23), a saw space (24) and a scissors space (25); the front ends of the slice (14)(15)(16) that correspond to the scissors space (25) are not fixed by the pivot (22) and become free end (141)(151)(161), the slice (16) is shorter than others and offers a free space (162) in front.

A cover (30), as shown in FIG. 3, is a hollow structure with cross section in “U” shape, one end of the cover (30) connects to the end of the container (10) moveably with the pivot (20), such scheme can make the cover (30) covers on top of the container (10); several concave, protruded point (33)(34) are on the inner wall of the cover (30) and the outer wall of outmost slice (11)(19), when the cover (30) covers the container (10), the concave, protruded point (33)(34) fasten the cover (30) from opening accidentally.

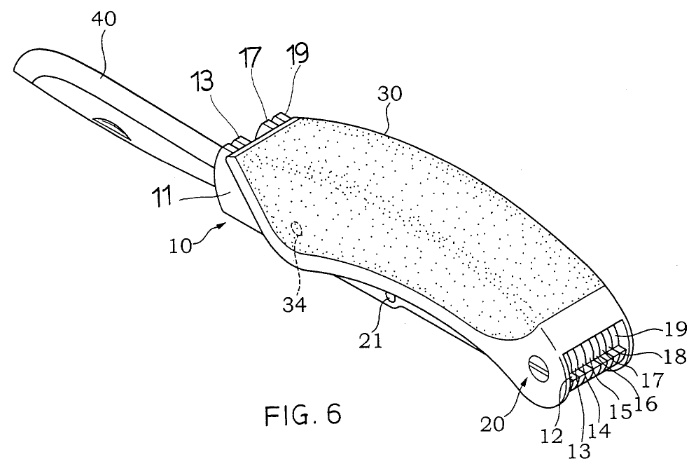

A knife blade (40), as shown in FIG. 3 to FIG. 6, with one end connects to the front of the container (10) moveably inside the knife space (23) with the pivot (22); users can turn the knife blade (40) outward to cut or turn inward into the knife space (23).

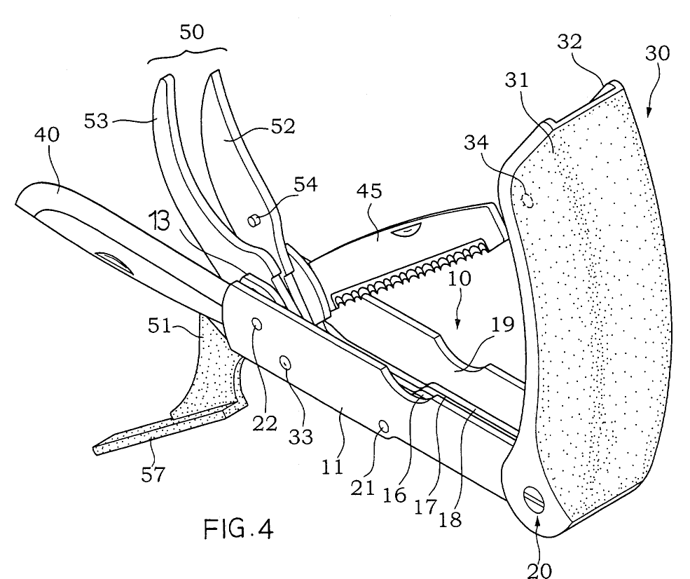

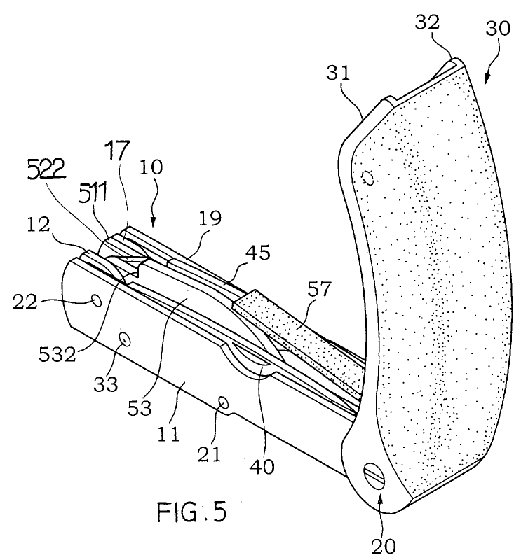

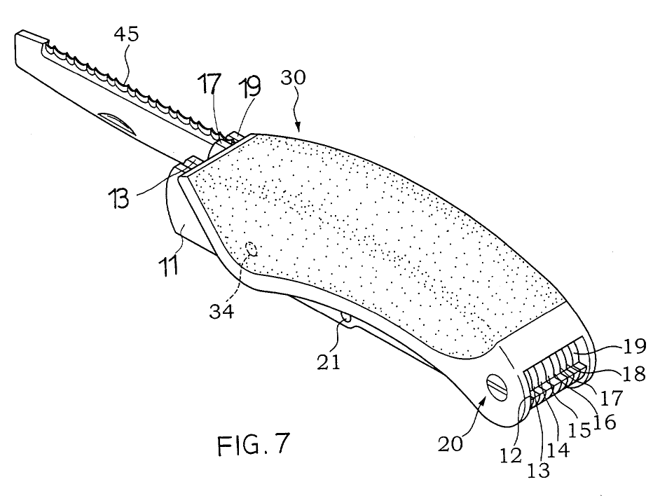

A saw blade (45), as shown in FIG. 3, FIG. 4, FIG. 5 and FIG. 7, with one end connects to the front of the container (10) moveably inside the saw space (24) with the pivot (22); users can turn the knife blade (45) outward to saw or turn inward into the knife space (24).

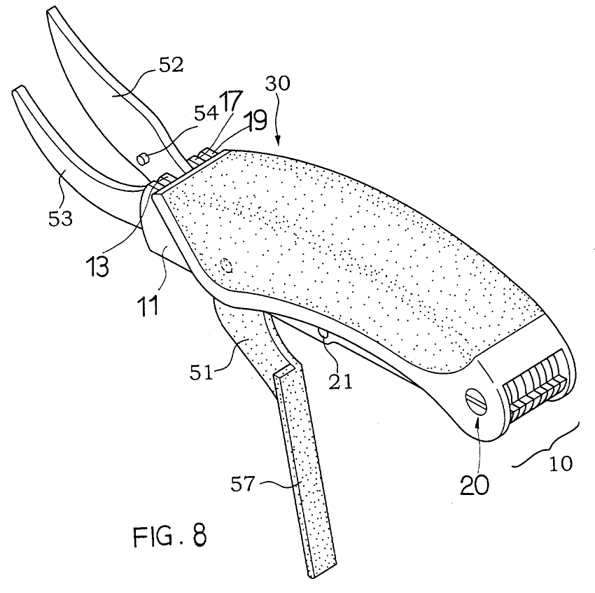

A scissors (50), as shown in FIG. 3, FIG. 4, FIG. 5 and FIG. 8, consists of a control handle (51), a first scissors blade (52) and a second scissors blade (53); the first scissors blade (52) is in ax shape, the second scissors blade (53) is in new moon shape. The wedged ends (511)(521)(531) of the control handle (51), the first scissors blade (52) and the second scissors blade (53) are connected to the front of the container (10) moveably inside the saw space (24) with the pivot (22); the control handle (51) is installed on top of the free space (162) and behind the first scissors blade (52); a pressing inclination (522) and an indent (532) are near the wedged end (521)(531) of the edge side of the first and the second scissors blade (52)(53) respectively; the scissors (50) can be folded into the container (10) or pulled out of the container (10). A protruding pin (54) is on the first scissors blade (52) and faces the second scissors blade (53); a protruding rod (55) and a curve shape hole (56) are on the first scissors blade (52) and the control handle (51) respectively, the protruding rod (54) inserts into the curved shape hole (56). A pushing end (57) is installed on the end of the control handle (51) with the bent protruding side faces the direction of the first and the second scissors blade (52)(53). The operation of the scissors (50) is described below:

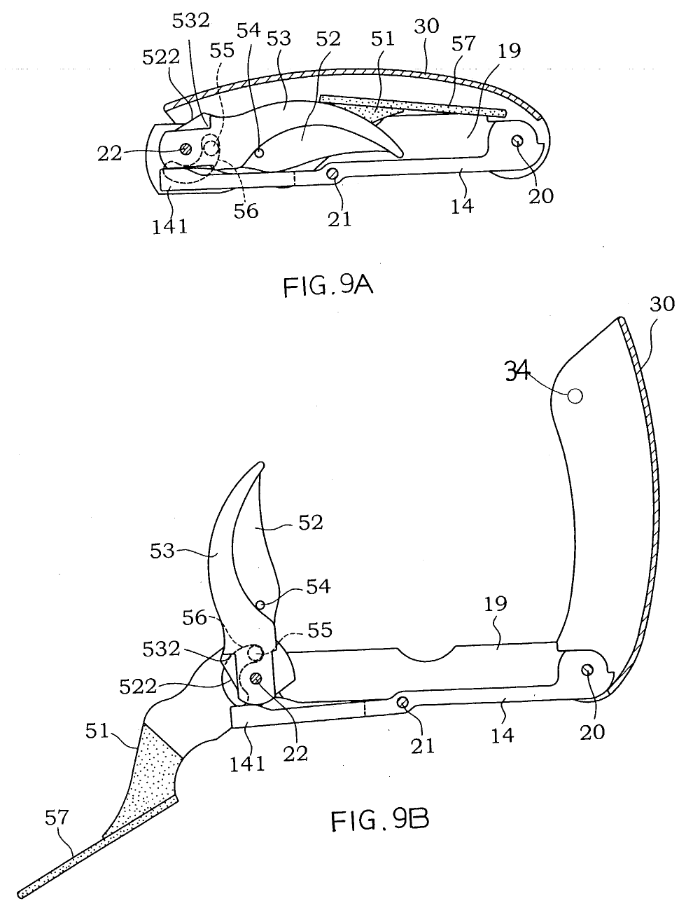

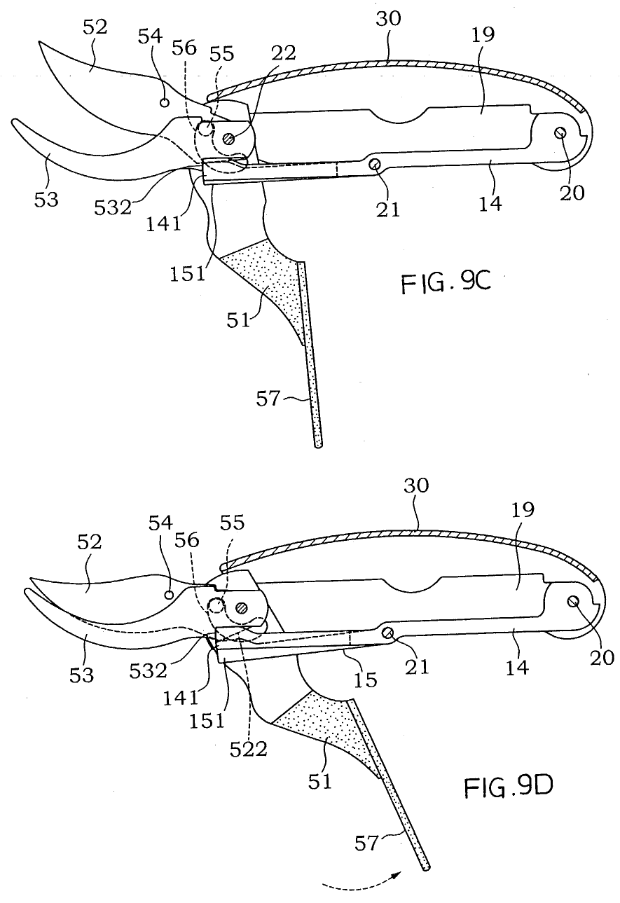

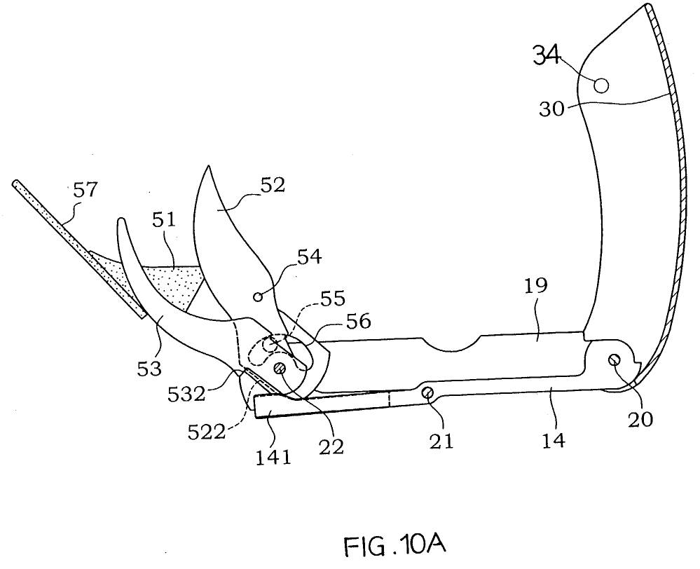

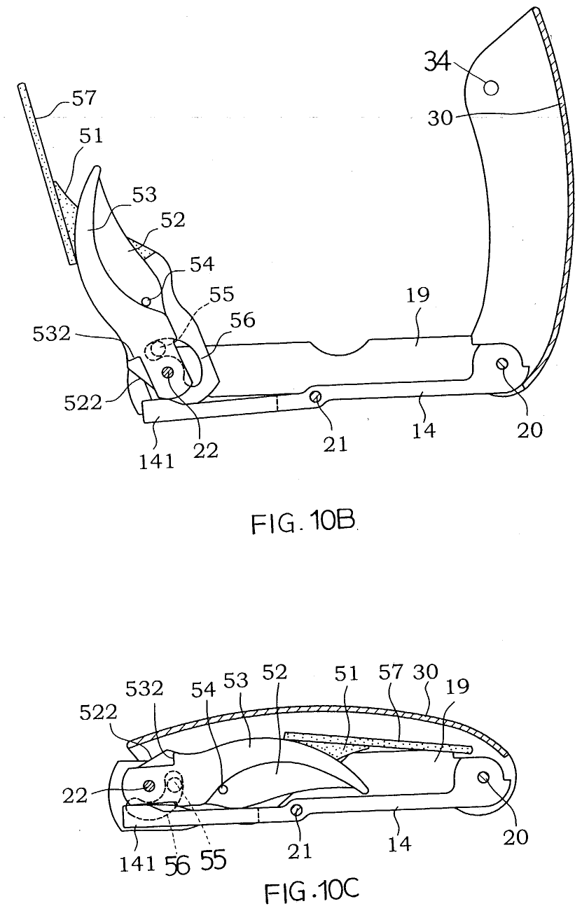

Referring to FIGS. 9A to 9D, when the scissors (50) is inside the container (10), users can pull the pushing end (57) to move the control handle (51) out of the container (10), the control handle (51) is on top of the free space (162) of the slice (16), therefore the control handle (51) turns and goes into the free space (162) further, the curve shape hole (56) moves along with the control handle (51), when the end of the curve shape hole (56) touches the protruding rod (55) of the first scissors blade (52), the first scissors blade (52) is pulled out along the by the control handle (51), when the protruding pin (54) of the first scissors blade (52) touches the edge of second scissors blade (53), the second scissors blade (53) is pulled out; when the control handle (51) is beneath the container (10), the first and the second scissors blade (52)(53) are on the front of the container (10); when the scissors (50) turns outward and opens, the pressing inclination (522) of the first scissors blade (52) presses onto the free end (151) of the slice (15), the indent (532) of the second scissors (53) is blocked on the free end (141) of the corresponding slice (14); at this time, the first and the second scissors blade (52)(53) open and separate apart; the cover (30) is then folded back to cover the container (10) and combines with the control handle (51) to form a pair of grips of the flower scissors for users; when users grip the control handle (51) and the cover (10), the control handle (51) pulls the first scissors blade (51) with one end of the curve shape hole (56) pulling the protruding rod (55), at the same time, the first scissors blade (52) presses the free end (151) of the slice (15) with pressing inclination (522), the free end (151) is bent downward; the fist scissors blade (52) leans toward the second scissors blade (53) to trim and cut; when users release the control handle (51), the pressed free end (151) of slice (15) moves back and pushes the first and the second scissors blade (52)(53) separate apart and open. Users can keep gripping the control handle (51) can have the scissors (50) to do trim and cut operation. Referring to FIGS. 10A to 10C, when the scissors (50) is to be recovered, users can push the control handle (51) backward till the pushing end (57) reaches the back of the second scissors blade (53), the second scissors blade (53) is pushed to the recovery direction; when the second scissors blade (53) touches the protruding pin (54) of the first scissors blade (52), the first scissors blade (52) is pushed to the recovery direction too, the first, the second scissors blade (52)(53) and the control handle (51) are folded into the scissors space (25) of the container (10) to finish the recovery operation.

The present invention has following advantages:

1. The present invention has not only a scissors (50) but also a knife blade (40) and a saw blade (45); users can apply them for different functions.

2. While using the scissors (50), the knife blade (40) or the saw blade (45) functions, users only have to pull the corresponding mechanism outward the container (10), and inward for recovery.

3. The cover (10) not only covers the container (10) for protection, but can be a handle for the knife blade (40) or the saw blade (45), it also acts as grip along with the control handle (51) for the scissors (50) to operate, to press and release to have the scissors (50) trim and open.

4. The cover (10) has a curve shape that is easy for users to grip.

5. The open and trim operations of the scissors (50) is caused by releasing of the first scissors blade (52) of the free end (151) of the slice (15), the strength of the slice (15) can be very strong and not easy to have elastic fatigue as spring, the product life can be longer.

6. While the scissors (50), the knife blade (40) and the saw blade (45) are not used, they hide inside the container (10) and protected by the cover (30), the concave, protruded (33)(34) between the cover (30) and the container (10) secure them firmly, the whole structure is in safe and stable condition.

7. While the scissors (50), the knife blade (40) and the saw blade (45) are not used and hide inside the container (10) to achieve small volume, easy to carry and easy to store effects.

While a preferred embodiment of the invention has been shown and described in detail, it will be readily understood and appreciated that numerous omissions, changes and additions may be made without departing from the spirit and scope of the invention.

What is claimed is:

1. A gardening flower scissors comprising:
a container with several slices in different structures, different shapes inside, said slices form at least a scissors space, one of said slice is shorter than others and offers a free space in front;
a cover located one end said container and covering said container;
a scissors consisting of a control handle, a first scissors blade and a second scissors blade, the wedged ends of said control handle, said first scissors blade and said second scissors blade being connected to the front of said container, said control handle installed on top of the free space, a protruding pin located on said first scissors blade and facing said second scissors blade, a protruding rod and a curve shape hole located on said first scissors blade and said control handle respectively, said protruding rod inserting into said curved shape hole, a pressing inclination and an indent located near said wedged end of the edge side of said first and said second scissors blade respectively, said scissors being folded into said container or pulled out of said container.

2. The gardening flower scissors with container recited in claim 1, wherein said slices inside said container form a knife space.

3. The gardening flower scissors with container recited in claim 2, wherein a knife blade with one end connecting to the front of said container moveably inside said knife space, said knife blade being turned outward to cut or turned inward into said knife space.

4. The gardening flower scissors with container recited in claim 1, wherein said slices inside said container form a saw space.

5. The gardening flower scissors with container recited in claim 4, wherein a saw blade with one end connecting to the front of said container moveably inside said saw space, said saw blade being turned outward to saw or turned inward into said saw space.

6. The gardening flower scissors with container recited in claim 1, wherein said cover in a hollow structure with cross section in “U” shape, several concave, protruded points located on the inner wall of said cover and the outer wall of outmost slices, when said cover covers said container, said concave, protruded points fasten said cover.

7. The gardening flower scissors with container recited in claim 1, wherein said first scissors blade in ax shape, said second scissors blade in new moon shape.

8. The gardening flower scissors with container recited in claim 1, wherein a pushing end installed on the end of said control handle with the bent protruding side facing the direction of said first and said second scissors blade.

9. The gardening flower scissors with container recited in claim 1, wherein said pushing end turning to the front of said container into said free space the end of said curve shape hole touches said protruding rod of said first scissors blade, said first scissors blade is pulled out along, said protruding pin of said first scissors blade touches the edge of said second scissors blade, said second scissors blade is pulled out;

10. The gardening flower scissors with container recited in claim 9, wherein said pressing inclination of said first scissors blade pressing onto said free end, said indent of said second scissors being blocked on said free end of said corresponding slice, said first and said second scissors blades open and separate apart.

11. The gardening flower scissors with container recited in claim 10, wherein said cover being folded back to cover said container and combining with said control handle to form a pair of grips for users.

12. The gardening flower scissors with container recited in claim 1, wherein said slices being fixed on center and both ends with pivots.

13. The gardening flower scissors with container recited in claim 12, wherein the front ends of said slices corresponding to said spaces are not fixed by said pivot.

14. The gardening flower scissors with container recited in claim 12, wherein one end of said cover connecting to the end of said container moveably with said pivot.

15. The gardening flower scissors with container recited in claim 12, wherein one end of said saw blade connecting to the front of said container moveably inside said saw space with said pivot.

16. The gardening flower scissors with container recited in claim 12, wherein said control handle, said first scissors blade and said second scissors blade connecting to the front of said container moveably inside said saw space with said pivot.
